(19) United States
(12) Patent Application Publication
(10) Pub. No.: US 2010/0138398 A1
(43) Pub. Date: Jun. 3, 2010

(54) Update management apparatus and update management method

(75) Inventor: Naomi Yoshizawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/656,277

(22) Filed: Jan. 22, 2010

Related U.S. Application Data
(63) Continuation of application No. PCT/JP07/64783, filed on Jul. 27, 2007.

(51) Int. Cl. G06F 17/00; G06F 7/00

(52) U.S. Cl. 707/690; 707/812; 707/E17.044; 707/E17.005

(57) ABSTRACT

To ensure consistency with a structure of a schema set stored in a database, i.e., an original source of an update request, the following processing is performed: storing reference relation for specifying another database storing a related schema set to be updated in accordance with an update of a structure of a schema set stored in a database, i.e., a request source of the update request; deciding whether a content of an update request is related to a structure change of the schema set; extracting, when the content of the update request is related to the structure change of the schema set, based on the reference relation, the other database storing an associated schema set to be updated to ensure consistency; deciding whether to update the extracted database; and sending an update approval/disapproval decision result to the database, i.e., the original source of the update request.

### CROSS-REFERENCE TO RELATED APPLICATION

This application is a continuation of International Application No. PCT/JP2007/064783, filed on Jul. 27, 2007, the entire contents of which are incorporated herein by reference.

### FIELD

The embodiments discussed herein are directed to update management apparatuses, and update management methods.

### BACKGROUND

Conventionally, a technology in which prescribed schema or data associated with a plurality of different databases used by different users and administrators is distributed and stored in a database (see Japanese Laid-open Patent Publication No. 2000-187603 and Japanese Laid-open Patent Publication No. 2004-145635). The associated schema set mentioned here indicates, for example, a schema that has the data that is created by quoting data of another schema or a schema that has the data that is created by processing using prescribed data of another schema, and multi data set and schema set that are updated by a single transaction. Specifically, when prescribed schema has been updated, schema associated with the updated schema is updated at the same time to ensure consistency with the associated schema. Even when using schema set that is hierarchically created, for example, by quoting data set to create another piece of data and further quoting the created data to create another piece of data, the pieces of data associated with each other are updated at the same time, whereby consistency of the associated data is ensured.

When updating a structure of a schema set stored in a database, because effects due to the update are large, by executing the update of the structure of the schema set after authorization for the update is received from an administrator who manages a database affected by the update of the structure of the schema set, thus the consistency of the associated schema set is ensured.

With the above-described conventional technology, it is impossible to efficiently send a query about authorization for the update to the administrator managing another database; therefore, the update of the structure of the schema set is complicated.

Specifically, in a case where a schema set is hierarchically created, for example, by quoting data set to create another piece of data and further quoting the created data to create another piece of data, a region affected by the update of the structure of the schema set is large; therefore, it is difficult to accurately specify the affected region. Accordingly, it is not possible to execute a structure change in which the affected region of the update of the structure of the schema set is not specified.

Even when the affected region of the schema set affected by the update of the structure of the schema set can be specified, authorization for the update needs to be individually obtained from the administrators who manage the database storing the schema set affected due to the update, which is a large burden for users who perform the update.

### SUMMARY

According to an aspect of an embodiment of the invention, an update management apparatus that performs a process with respect to an update request when the update request occurs in any one of a plurality of databases storing a prescribed schema set that is distributed and hierarchically associated, includes a reference relation storing unit that stores, in advance, reference relation for specifying other database storing a related schema set that needs to be updated in accordance with an update of a structure of a schema set stored in a database that is a request source of the update request to ensure consistency with a structure of a schema set stored in a database that is an original source of the update request; an update-content decision unit that decides whether a content of the update request is related to a structure change of the schema set; an update approval/disapproval deciding unit that extracts, when the update-content decision unit decides that the content of the update request is related to the structure change of the schema set, on the basis of the reference relation stored by the reference relation storing unit, other database storing an associated schema set that needs to be updated to ensure the consistency and decides whether to approve an update of the extracted database; and an update approval/disapproval decision result sending unit that sends an update approval/disapproval decision result decided by the update approval/disapproval deciding unit to the database that is the original source of the update request.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram that explains the outline and features of an update management system according to a first embodiment;

FIG. 2 is a block diagram illustrating the configuration of an aggregation management apparatus;

FIG. 3 is an example of a data table stored in a reference relation storing unit;

FIGS. 4A to 4D are examples of a data table stored in the reference relation storing unit;

FIG. 5 is a block diagram illustrating the configuration of a database management apparatus;

FIG. 6 is an example of an authorization determination table;

FIG. 7 is a flowchart illustrating a process in a case where an update request occurs in the database management apparatus;

FIG. 8 is a flowchart illustrating a process in a case where the aggregation management apparatus receives an approval/disapproval query;

FIG. 9 is a flowchart illustrating a process in a case where the database management apparatus receives a request for an update authorization;

FIG. 10 is a flowchart illustrating a process in a case where the aggregation management apparatus receives a reply about approval/disapproval of the authorization request;

FIG. 11 is a flowchart illustrating a process in a case where the database management apparatus receives an approval/disapproval determination result;

FIG. 12 is an example of a data table stored in the reference relation storing unit;

FIG. 13 is an example of an authorization determination table; and

FIG. 14 is a block diagram illustrating a computer that executes an update management program.

### DESCRIPTION OF EMBODIMENT(S)

Preferred embodiments of the present invention will be explained with reference to accompanying drawings.

In the following description, a case in which the update management program according to the present invention is applied to the update management system that includes the database management apparatus and the aggregation management apparatus is described as an embodiment of the present invention.

### [a] First Embodiment

In a first embodiment, the outline and features of the update management system according to the first embodiment, the configuration of the update management system, and a flow of processing thereof are described in the order they appear in this sentence, and then advantages of the first embodiment are described.

Outline and Features of the Update Management System (the First Embodiment)

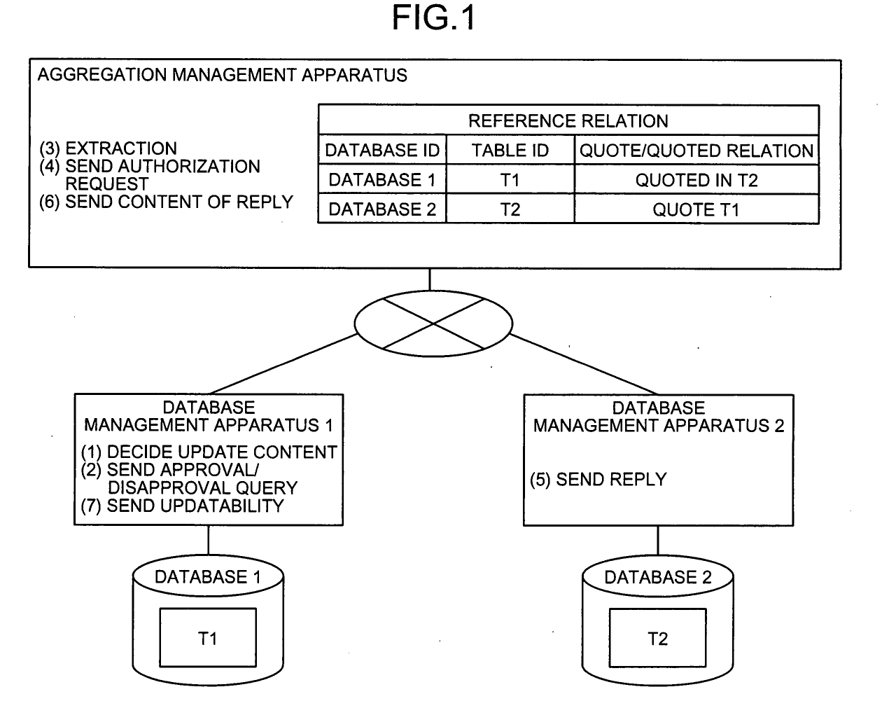

First, the outline and features of the update management system according to the first embodiment are described with reference to FIG. 1. FIG. 1 is a schematic diagram that explains the outline and features of the update management system according to the first embodiment.

As illustrated in FIG. 1, the update management system according to the first embodiment includes a plurality of databases that store prescribed schema that is distributed and associated in each hierarchy (for example, database 1 and database 2); a plurality of database management apparatuses that are arranged in association with each of the databases and receive an update request occurring in a schema set stored in a database associated with a corresponding one of the database management apparatus (for example, database management apparatus 1 and database management apparatus 2); and an aggregation management apparatus that receives an approval/disapproval query about the update request from one of the database management apparatuses.

The stored data that is distributed in each hierarchy indicates, in general, the data structured according to a schema or an E-R model, and, for example, the data set that is stored in another database and created by quoting another piece of data set stored in a predetermined database and further quoting the created data set.

With such a configuration, in outline, the update management system according to the first embodiment performs a process for updating the data that is distributed in each hierarchy and stored in the plurality of databases. The main feature of the update management system according to the first embodiment is that, when an update request for the structure of the schema set occurs, the update management system extracts another database that stores a schema set affected by the update and sends a collective query about update authorization to an administrator who manages the other database to efficiently obtain the update authorization, thus easily updating the structure of the schema set.

The structure mentioned here indicates, for example, the configuration of data hierarchically structured according to a schema or an E-R model and corresponds to the configuration in which a data table is divided into individual items. A structure change corresponds to, for example, changes of item names and additions or deletions of items in the data table.

The main features of the update management system are specifically described below. As illustrated in FIG. 1, to ensure consistency with a structure of a schema set stored in a database that is an original source of an update request, the aggregation management apparatus according to the first embodiment stores, in advance, reference relation for specifying another database that stores a related schema set that needs to be updated in accordance with an update of a structure of a schema set stored in a database that is a request source of the update request.

Specifically, the aggregation management apparatus according to the first embodiment stores, as the reference relation, a database ID that is an identifier of the database storing data (for example, “database 1”); a table identifier that is an identifier of the data table stored in the database (for example, “T1”); and a quote/quoted relation that is data indicating whether the data table is quoted for creating another data table (for example, “quoted in T2”), or data indicating that the data table is created on the basis of which data table (for example, “quote T1”), which are associated with each other.

When an update request occurs, the database management apparatus decides whether the content of the update request is related to an update of the structure of the schema set (see (1) in FIG. 1). Specifically, when the database management apparatus 1 receives, from a user or the database 1, an update request indicating that the data stored in the database 1 is to be updated, the database management apparatus 1 decides whether the update request is related to an update of the structure of the schema set (for example, update request for changing an item name in the data table), or the update request is not related to an update of the structure of the schema set (for example, change request for a record in the data table).

The record mentioned here indicates a single set or multiple sets of values constituting the data table and corresponds to all data, for example, the name of a certain employee, department names, or the like.

When it is decided that the content of the update request is related to the update of the structure of the schema set, the database management apparatus sends an approval/disapproval query about the update request to the aggregation management apparatus (see (2) of FIG. 1). Specifically, when it is decided that the content of the update request is related to the update of the structure of the schema set, the database management apparatus 1 sends a query about whether to approve/disapprove the execution of the update of the structure of the schema set to the aggregation management apparatus.

When the database management apparatus sends the approval/disapproval query, the aggregation management apparatus extracts, on the basis of the reference relation, the other database storing the associated schema set that needs to be updated to ensure consistency (see (3) in FIG. 1) and sends an authorization request for the update to the database management apparatus that is arranged in association with the extracted database (see (4) in FIG. 1).

Specifically, when the aggregation management apparatus receives the approval/disapproval query about the execution of the update of the structure of the schema set from the database management apparatus 1, the aggregation management apparatus confirms, by referring to the quote/quoted relation in the reference relation, that “a table 2 in the database 2 contains data created by quoting from a table 1 in the database 1”. Thereafter, the aggregation management apparatus extracts the database 2 that needs to be updated in accordance with the update of the database 1 and sends a query about whether to authorize the update of the structure of the schema set in the database 1 to the database management apparatus 2 associated with the extracted database 2.

After receiving the authorization request for the update request from the aggregation management apparatus, the database management apparatus sends a reply to the authorization request for approval/disapproval (see (5) in FIG. 1). Specifically, when the database management apparatus 2 receives the query about whether to authorize the update of the structure of the schema set in the database 1 from the aggregation management apparatus, the database management apparatus 2 decides whether to authorize the update and sends a decision result as a reply to the aggregation management apparatus.

When the aggregation management apparatus receives the reply to the authorization request for approval/disapproval sent from the database management apparatus, the aggregation management apparatus decides whether to approve the approval/disapproval query and sends a decision result as an approval/disapproval determination result to the database management apparatus that is a sending source of the approval/disapproval query (see (6) in FIG. 1). Specifically, when the aggregation management apparatus receives a decision result of the authorization for the update of the structure of the schema set from the database management apparatus 2, the aggregation management apparatus sends an approval/disapproval determination result indicating permission to execute the update of the structure of the schema set to the database management apparatus 1, and when the aggregation management apparatus receives a decision result indicating un-authorization for the update of the structure of the schema set from the database management apparatus 2, the aggregation management apparatus sends an approval/disapproval determination result indicating restriction on the update of the structure of the schema set to the database management apparatus 1.

When the database management apparatus receives the approval/disapproval determination result from the aggregation management apparatus, on the basis of the result of the approval/disapproval query, the database management apparatus sends the updatability of the update request to the database in which the update request occurs (see (7) in FIG. 1). Specifically, when the database management apparatus 1 receives the approval/disapproval determination result indicating permission to execute the update of the structure of the schema set from the aggregation management apparatus, the database management apparatus 1 sends the approval of the update of the structure of the schema set to the database 1, and when the database management apparatus 1 receives the approval/disapproval determination result indicating the restriction on the update of the structure of the schema set from the aggregation management apparatus, the database management apparatus 1 notifies or sends the restriction on the update of the structure of the schema set to a user or the database 1.

In this way, when the update request for the structure of the schema set occurs, the update management system according to the first embodiment extracts the other database that stores a schema set affected by the update and sends the collective query about update authorization to the administrator who manages the other database to efficiently obtain the update authorization, which makes it possible to easily update the structure of the schema set.

Configuration of the Aggregation Management Apparatus (First Embodiment)

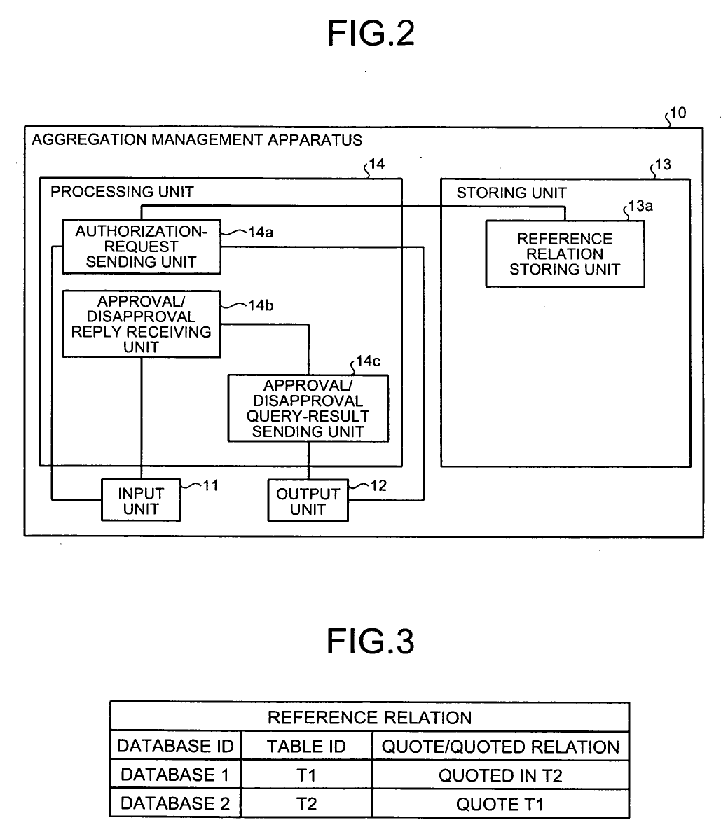

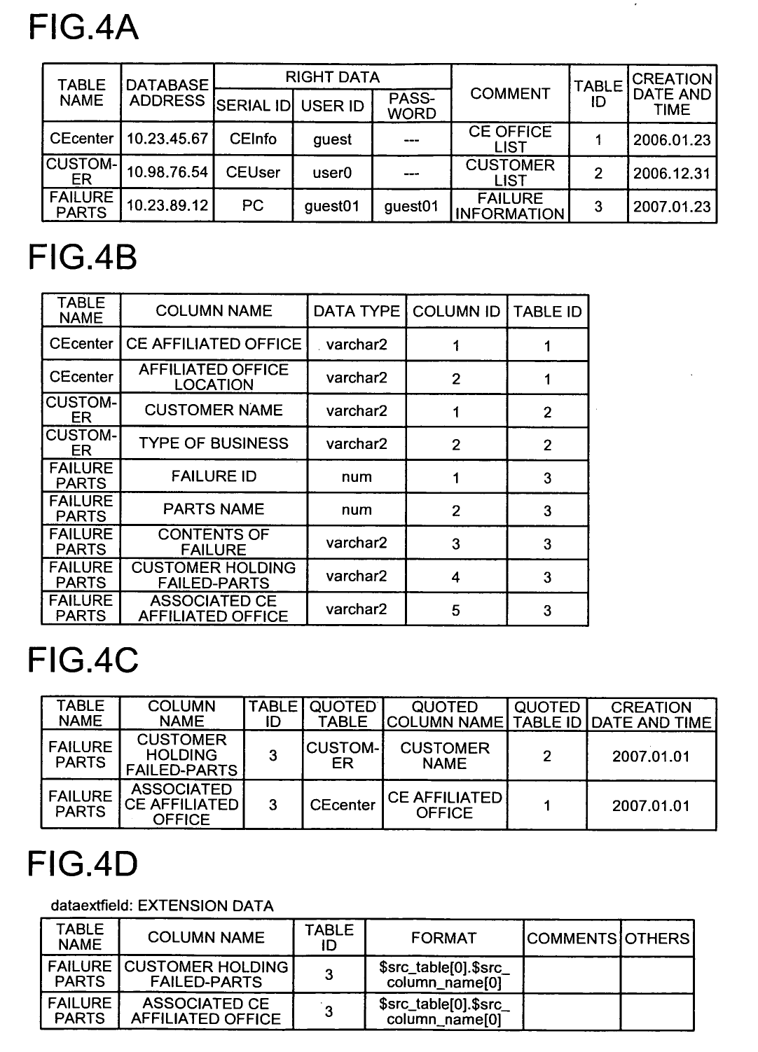

Next, the configuration of an aggregation management apparatus 10 included in the update management system illustrated in FIG. 1 is described with reference to FIGS. 2, 3, and 4. FIG. 2 is a block diagram illustrating the configuration of the aggregation management apparatus. FIG. 3 is an example of data table stored in a reference relation storing unit. FIGS. 4A to 4D are examples of data stored in the reference relation storing unit.

As illustrated in FIG. 2, the aggregation management apparatus 10 includes an input unit 11, an output unit 12, a storing unit 13, and a processing unit 14.

The input unit 11 receives inputs of various kinds of data and includes a single input port or multiple input ports. For example, an approval/disapproval query about an update request or a reply to an authorization request for approval/disapproval is received from the database management apparatus via the input unit 11.

The output unit 12 outputs various kinds of data and includes a single output port or multiple output ports. For example, an authorization request for an update or an approval/disapproval determination result indicating permission to update the structure of the schema set is sent to the database management apparatus via the output unit 12.

The storing unit 13 stores data and programs for various kinds of processes performed by the processing unit 14. The storing unit 13 includes a reference relation storing unit 13a, which is particularly and closely related to the present embodiment. The reference relation storing unit 13a corresponds to a storing unit in which reference relation is stored at a reference relation storing step in accordance with the present invention.

To ensure the consistency with a structure of a schema set stored in the database that is the original source of the update request, the reference relation storing unit 13a stores, in advance, reference relation for specifying the other database that stores a related schema set that need to be updated in accordance with an update of a structure of a schema set stored in the database that is the request source of the update request.

Specifically, as illustrated in FIG. 3, the reference relation storing unit 13a stores a database ID that is an identifier of the database storing data (for example, “database 1”); a table identifier that is an identifier of the data table stored in the database (for example, “T1”); and a quote/quoted relation that is data indicating whether the data table is quoted for creating another data table (for example, “quoted in T2”), or data indicating that the data table is created on the basis of which data table (for example, “quote T1”), which are associated with each other.

As illustrated in FIGS. 4A to 4D, the reference-related-data storing unit 13a can further store names of data tables or creation date and time of the data tables, which are stored in databases, and addresses of databases (for example, 10.23.45.67, etc.); right data for accessing databases (for example, serial IDs, user IDs, passwords, etc.); structures of data tables stored in databases (for example, column names of data tables, column IDs of data tables, data types of the stored data (character strings, numerals, etc.)); and storage areas of quote sources or processing methods (formats) when data tables are created by processing another data table.

FIG. 4A is an example of registration table for managing a database. FIG. 4B is an example of column names and column values in the registration table for managing the columns stored in the table. FIG. 4C is an example of quote/quoted relation data for managing the quote/quoted relation. FIG. 4D is an example of extension data that further illustrates the quote/quoted relation data in detail.

The processing unit 14 has an internal memory for storing a control program such as an operating system (OS) and necessary data and programs prescribing various kinds of procedures, whereby various kinds of processes are executed. The processing unit 14 includes, in particular, as closely related to the present invention, an authorization-request sending unit 14a, an approval/disapproval reply receiving unit 14b, and an approval/disapproval query-result sending unit 14c. The authorization-request sending unit 14a corresponds to an authorization-request sending unit of the present invention, the approval/disapproval reply receiving unit 14b corresponds to an approval/disapproval reply receiving unit of the present invention, and the approval/disapproval query-result sending unit 14c corresponds to an approval/disapproval query-result sending unit of the present invention.

When an approval/disapproval query is received from the database management apparatus, the authorization-request sending unit 14a extracts, on the basis of the reference relation stored in the reference relation storing unit 13a, the other database storing the associated schema set that needs to be updated to ensure consistency and sends an authorization request for the update to the database management apparatus that is arranged in association with the extracted database.

Specifically, the authorization-request sending unit 14a receives, from the database management apparatus 1, a change in the update of a structure of a schema set (for example, a change indicating that an item name A in the data table 1 stored in the database 1 is changed to an item name B) as an approval/disapproval query about whether to execute an update of a structure of a schema set. Thereafter, by referring to the reference relation stored in a reference relation storing unit 15 on the basis of the “data table 1”, the authorization-request sending unit 14a extracts the quote/quoted relation indicating that “the table 1 (T1) is quoted in the table 2 (T2)” and extracts data indicating that “the table 2 is stored in the database 2”.

Furthermore, the authorization-request sending unit 14a sends, to the database management apparatus 2 associated with the extracted database 2, a query about whether to authorize the update of the structure of the schema set in the database 1 by sending “the change indicating that the item name A in the data table 1 stored in the database 1 is changed to the item name B”. In this example, although there is only one database management apparatus associated with the extracted database, if a plurality of databases are extracted, the authorization-request sending unit 14a sends “the change indicating that the item name A in the data table 1 stored in the database 1 is changed to the item name B” to all the database management apparatuses associated with the extracted databases.

The approval/disapproval reply receiving unit 14b receives a reply to the authorization request for approval/disapproval sent from the database management apparatus. Specifically, the approval/disapproval reply receiving unit 14b receives a reply to the authorization request for approval/disapproval sent from the database management apparatus 2 (for example, “a reply of authorization for the change indicating that the item name A in the data table 1 stored in the database 1 is changed to the item name B”). This example is a case where the reply to the authorization request for approval/disapproval is received only from the database management apparatus 2; however, the reply to the authorization request for approval/disapproval is received from all database management apparatuses associated with the databases extracted by the authorization-request sending unit 14a.

The approval/disapproval query-result sending unit 14c decides whether to approve the approval/disapproval query on the basis of the reply received by the approval/disapproval reply receiving unit 14b and sends a decision result as an approval/disapproval determination result to the database management apparatus that is the sending source of the approval/disapproval query.

Specifically, the approval/disapproval query-result sending unit 14c decides whether to approve the approval/disapproval query on the basis of the content of the reply received by the approval/disapproval reply receiving unit 14b. For example, when the approval/disapproval reply receiving unit 14b receives “a reply of authorization for a change indicating that the item name A in the data table 1 stored in the database 1 is changed to the item name B”, the approval/disapproval query-result sending unit 14c sends “an approval/disapproval determination result indicating permission to execute the update of the structure of the schema set” to the database management apparatus 1, and when the approval/disapproval reply receiving unit 14b receives “a reply of un-authorization for the change indicating that the item name A in the data table 1 in the database 1 is changed to the item name B”, the approval/disapproval query-result sending unit 14c sends “the approval/disapproval determination result indicating the restriction on the update of the structure of the schema set” to the database management apparatus 1.

This example is a case where the approval/disapproval reply receiving unit 14b receives the reply to the authorization request for approval/disapproval only from the database management apparatus 2; however, after the approval/disapproval reply receiving unit 14b receives replies to the authorization request for approval/disapproval from the database management apparatuses associated with all databases extracted by the authorization-request sending unit 14a, and only when all of the replies are “replies of authorization for the change indicating that the item name A in the data table 1 stored in the database 1 is changed to the item name B”, the approval/disapproval query-result sending unit 14c sends “the approval/disapproval determination result indicating permission to execute the update the structure of the schema set”. In contrast, when the approval/disapproval reply receiving unit 14b receives at least one reply of “un-authorization for a change indicating that the item name A in the data table 1 stored in the database 1 is changed to the item name B” from the database management apparatus associated with the database extracted by the authorization-request sending unit 14a, the approval/disapproval query-result sending unit 14c sends “the approval/disapproval determination result indicating the restriction on the update of the structure of the schema set” to the database management apparatus 1.

Configuration of the Database Management Apparatus (First Embodiment)

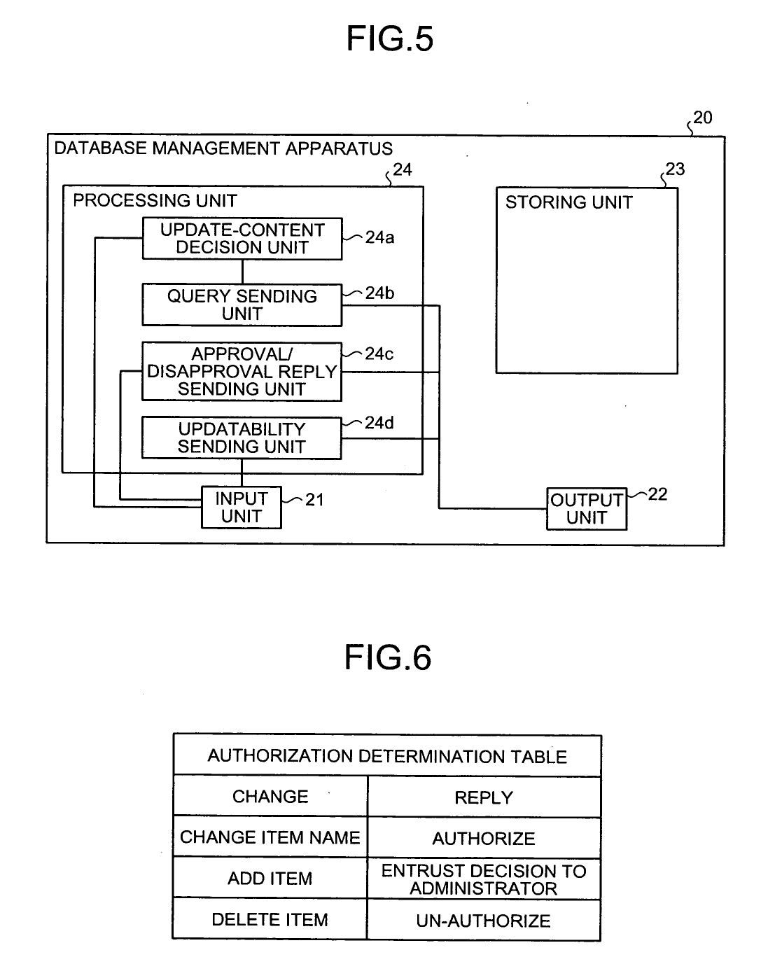

Next, the configuration of a database management apparatus 20 in the update management system illustrated in FIG. 1 is described with reference to FIGS. 5 and 6. FIG. 5 is a block diagram illustrating the configuration of the database management apparatus. FIG. 6 is an example of an authorization determination table.

As illustrated in FIG. 5, the database management apparatus 20 includes an input unit 21, an output unit 22, a storing unit 23, and a processing unit 24. The database management apparatus 1 and the database management apparatus 2 described in the first embodiment have the same configuration as the database management apparatus 20 and perform processing in a similar manner.

The input unit 21 receives inputs of various kinds of data and includes a keyboard, a mouse, a single input port or a plurality of input ports, and the like. For example, via the input unit 21, an update request indicating an update of data stored in the database 1 is received from a user or the database 1 associated with the input unit 21, and an authorization request for an update request or an approval/disapproval determination result of the approval/disapproval query about an update request is received from the aggregation management apparatus 10.

The output unit 22 outputs various kinds of data and includes a monitor (or a display or a touch panel), a single input port or plurality of input ports, and the like. For example, an approval/disapproval query about an update request or a decision result of approval/disapproval of an update of a structure of a schema set is sent to the aggregation management apparatus 10 via the output unit 22, and a notification indicating the restriction on the update of the structure of the schema set is sent to the user or the database 1.

The storing unit 23 stores data and programs for various kinds of processes performed by the processing unit 24.

The processing unit 24 has an internal memory for storing a control program such as an operating system (OS), necessary data and programs prescribing various kinds of procedures, whereby various kinds of processes are executed. The processing unit 24 includes, in particular, as closely related to the present invention, an update-content decision unit 24a, a query sending unit 24b, an approval/disapproval reply sending unit 24c, and an updatability sending unit 24d. The update-content decision unit 24a corresponds to the update-content decision unit of the present invention, the query sending unit 24b corresponds to the query sending unit of the present invention, the approval/disapproval reply sending unit 24c corresponds to the approval/disapproval reply sending unit of the present invention, and the updatability sending unit 24d corresponds to the updatability sending unit of the present invention.

When an update request occurs, the update-content decision unit 24a decides whether the content of the update request is related to the update of the structure of the schema set. Specifically, when the update-content decision unit 24a receives, from the user or the database 1 via the input unit 21, the update request indicating that the data stored in the database 1 is to be updated, the update-content decision unit 24a decides whether the content of the update request is related to the update of the structure of the schema set (for example, update request for changing the item name in the data table), or the update request is not related to the update of the structure of the schema set (for example, a change request for a record in the data table). Thereafter, when the content of the update request is not related to the update of the structure of the schema set, the update-content decision unit 24a sends “permission to execute the update of the structure of the schema set” to the database 1.

When the update-content decision unit 24a decides that the content of the update request is related to the update of the structure of the schema set, the query sending unit 24b sends an approval/disapproval query about the update request to the aggregation management apparatus 10. Specifically, when the update-content decision unit 24a decides that the content of the update request is related to an update of the structure of the schema set, the query sending unit 24b sends, to the aggregation management apparatus, a change in the update of the structure of the schema set (for example, the change indicating that the item name A in the data table 1 stored in the database 1 is changed to the item name B) as an approval/disapproval query about whether to execute the update of the structure of the schema set.

When the approval/disapproval reply sending unit 24c receives the authorization request for the update request from the aggregation management apparatus, the approval/disapproval reply sending unit 24c sends a reply to the authorization request for approval/disapproval. Specifically, when the approval/disapproval reply sending unit 24c receives “a change indicating that the item name A in the data table 1 in the database 1 is changed to the item name B” from the aggregation management apparatus, the approval/disapproval reply sending unit 24c decides whether to authorize the change and sends “a reply of authorization for the change indicating the item name A in the data table 1 stored in the database 1 is changed to the item name B” as a decision result to the aggregation management apparatus 10.

The process for deciding whether to authorize the change mentioned here is not limited to the present invention. For example, the storing unit 23 can store, in advance, the authorization determination table (see FIG. 6), in which a change (for example, changes in item names, or additions or deletions of items) is associated with a reply (for example, approvals/disapprovals, entrusting decisions to the administrator, etc.), for deciding whether to approve the change, and when the authorization request for the update request is received from the aggregation management apparatus, a decision whether to authorize the change can be made by referring to the authorization determination table. Furthermore, after entrusting the decision on the reply to the administrator, the approval/disapproval reply sending unit 24c can automatically send the reply of approval/disapproval to the aggregation management apparatus 10.

The replies stored in the authorization determination table can be associated with the items constituting the data table. Furthermore, when the administrator is entrusted to decide the reply, it is possible to use a method of sending emails about the change to the administrator or a method of notifying the administrator via a monitor with a pop-up message observed by the administrator.

When the updatability sending unit 24d receives an approval/disapproval determination result from the aggregation management apparatus, the updatability sending unit 24d sends the updatability of the update request to the database in which the update request occurs on the basis of the approval/disapproval query. Specifically, after receiving the approval/disapproval determination result from the aggregation management apparatus 10, the updatability sending unit 24d decides the approval/disapproval determination result. When the updatability sending unit 24d decides that “an approval/disapproval determination result is permission to execute the update of the structure of the schema set”, the updatability sending unit 24d sends “permission to execute the update of the structure of the schema set” to the database 1, and when the updatability sending unit 24d decides that “an approval/disapproval determination result is the restriction on the update of the structure of the schema set”, the updatability sending unit 24d notifies or sends “a restriction on the update of the structure of the schema set” to the user or the database 1.

Process Performed by the Update Management System

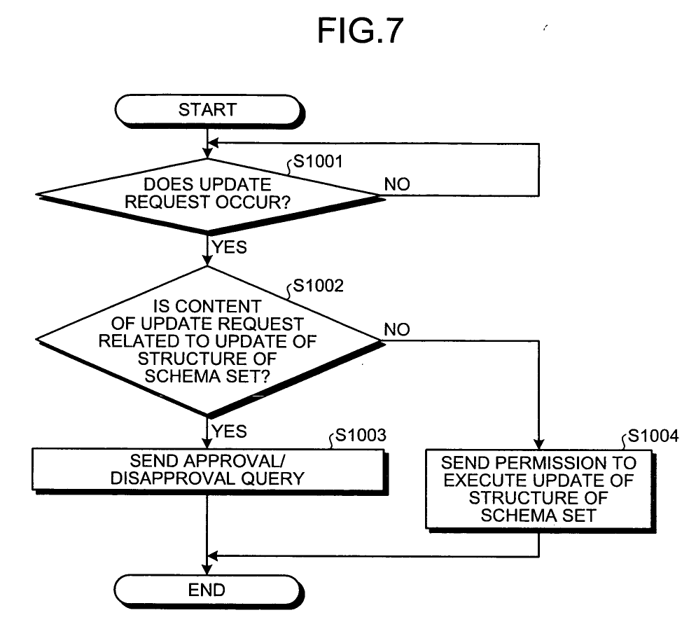

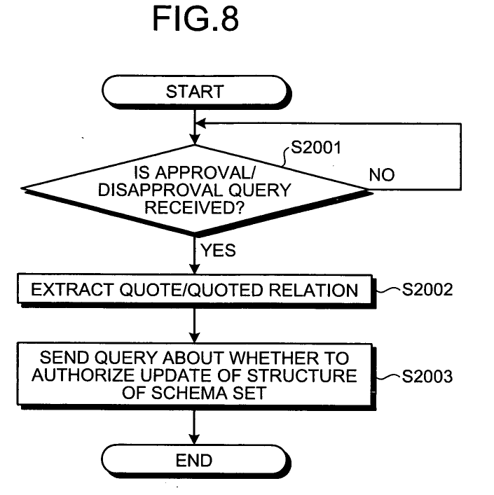

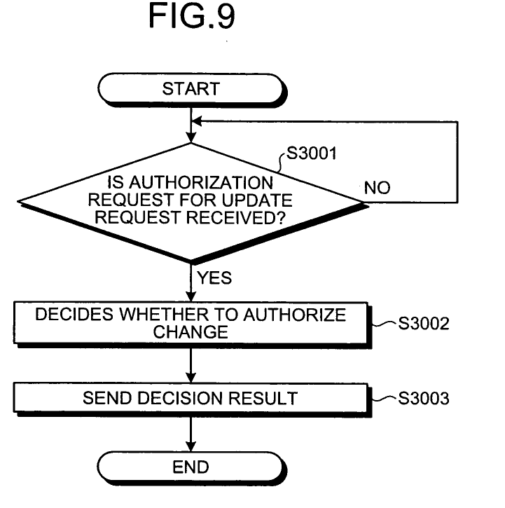

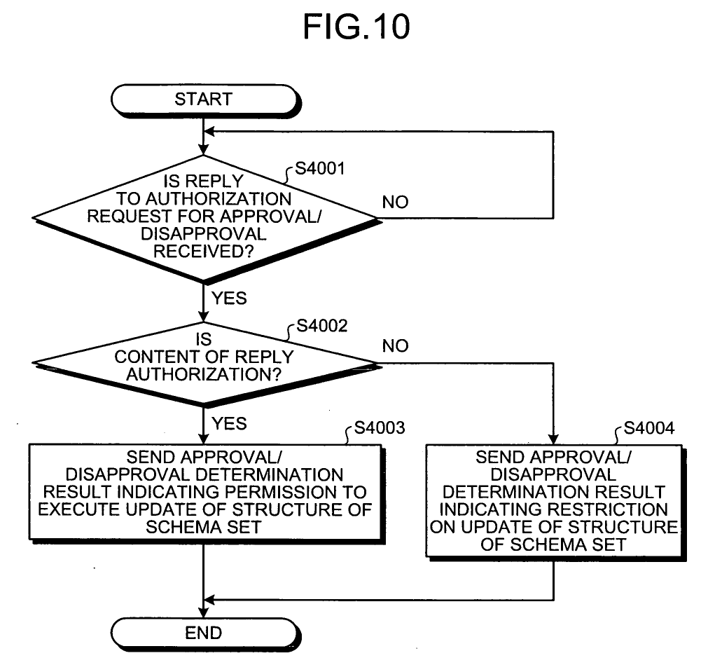

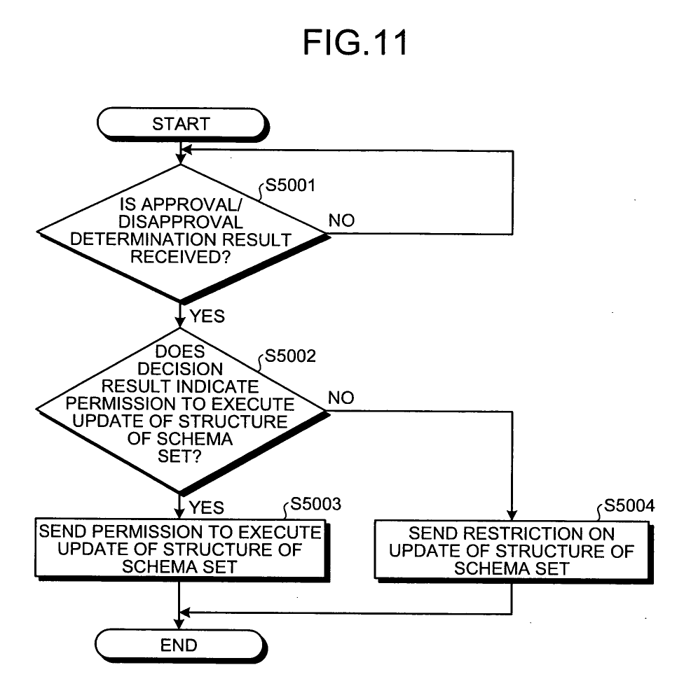

Next, a process performed by the update management system according to the first embodiment is described with reference to FIGS. 7 to 11. FIG. 7 is a flowchart illustrating a process in a case where an update request occurs in the database management apparatus. FIG. 8 is a flowchart illustrating a process in a case where the aggregation management apparatus receives an approval/disapproval query. FIG. 9 is a flowchart illustrating a process in a case where the database management apparatus receives an authorization request for an update request. FIG. 10 is a flowchart illustrating a process in a case where the aggregation management apparatus receives a reply about approval/disapproval of the authorization request. FIG. 11 is a flowchart illustrating a process in a case where the database management apparatus receives an approval/disapproval determination result.

Process in a Case where an Update Request Occurs in the Database Management Apparatus

First, a process in a case where an update request occurs in the database management apparatus is described with reference to FIG. 7. As illustrated in FIG. 7, when the update request indicating an update of the data stored in the database 1 is received from the user or the database 1 via the input unit 11 (Yes at Step S1001), the database management apparatus 20 decides whether the content of the update request is related to an update of a structure of a schema set (Step S1002).

When it is decided that the content of the update request is related to the update of the structure of the schema set (Yes at Step S1002), the database management apparatus 20 sends to the aggregation management apparatus 10 a change in the update of the structure of the schema set as an approval/disapproval query about whether to execute the update of the structure of the schema set (Step S1003), a process in a case where the update request occurs ends.

In contrast, when it is decided that the content of the update request is not related to the update of the structure of the schema set (No at Step S1002), the database management apparatus 20 sends permission to execute the update of the structure of the schema set to the database associated with the database management apparatus 20 (Step S1004), a process in a case where the update request occurs ends.

Process in a Case where the Aggregation Management Apparatus Receives the Approval/Disapproval Query

Next, a process in a case where the aggregation management apparatus receives the approval/disapproval query is described with reference to FIG. 8. As illustrated in FIG. 8, when the aggregation management apparatus 10 receives, from the database management apparatus 20, the change in the update of the structure of the schema set as the approval/disapproval query about whether to execute the update of the structure of the schema set (Yes at Step S2001), the aggregation management apparatus 10 extracts the quote/quoted relation by referring to the reference relation stored in the reference relation storing unit 13a (Step S2002).

Subsequently, the aggregation management apparatus 10 sends a query about authorization for the update of the structure of the schema set by sending the change to the database management apparatus associated with the extracted database (Step S2003), a process in a case where the approval/disapproval query is received from the database management apparatus ends.

Process in a Case where the Database Management Apparatus Receives an Authorization Request for the Update Request

Next, a process in a case where the database management apparatus receives an authorization request for the update request is described with reference to FIG. 9. As illustrated in FIG. 9, when the database management apparatus 20 receives an authorization request for the update request from the aggregation management apparatus (Yes at Step S3001), the database management apparatus 20 decides whether to authorize the change (Step S3002), sends a decision result to the aggregation management apparatus 10 (Step S3003), and ends the process in a case where the authorization request for the update request is received.

Process in a Case where the Aggregation Management Apparatus Receives a Reply to the Authorization Request for Approval/Disapproval

Next, a process in a case where the aggregation management apparatus receives a reply to the authorization request for approval/disapproval is described with reference to FIG. 10. As illustrated in FIG. 10, when the aggregation management apparatus 10 receives a reply to the authorization request for approval/disapproval sent from the database management apparatus (Yes at Step S4001), the aggregation management apparatus 10 decides whether to approve the approval/disapproval query on the basis of the content of the reply (Step S4002).

When the aggregation management apparatus 10 receives a reply of authorization for the change (Yes at Step S4002), the aggregation management apparatus 10 sends an approval/disapproval determination result indicating permission to execute the update of the structure of the schema set to the database management apparatus 20 (Step S4003), and when the aggregation management apparatus 10 receives a reply of un-authorization for the change (No at Step S4002), the aggregation management apparatus 10 sends an approval/disapproval determination result indicating the restriction on the update of the structure of the schema set to database management apparatus (Step S4004), and the process in a case where the reply to the authorization request for approval/disapproval is received ends.

Process in a Case where the Database Management Apparatus Receives the Approval/Disapproval Determination Result

Next, a process in a case where the database management apparatus receives the approval/disapproval determination result is described with reference to FIG. 11. As illustrated in FIG. 11, when the database management apparatus 20 receives the approval/disapproval determination result from the aggregation management apparatus 10 (Yes at Step S5001), the database management apparatus 20 decides the approval/disapproval determination result (Step S5002).

When the database management apparatus 20 decides that a decision result corresponds to the approval/disapproval determination result indicating permission to execute the update of the structure of the schema set (Yes at Step S5002), the database management apparatus 20 sends permission to execute the update of the structure of the schema set to the database (Step S5003). When the database management apparatus 20 decides that a decision result corresponds to the approval/disapproval determination result indicating the restriction on the update of the structure of the schema set (No at Step S5002), the database management apparatus 20 notifies the user or the database of the restriction on the update of the structure of the schema set (Step S5004), and the process in a case where the approval/disapproval determination result is received ends.

### Advantages of the First Embodiment

As described above, when an update request occurs, the database management apparatus decides whether the content of an update request is related to an update of a structure of a schema set. When the database management apparatus decides that the content of the update request is related to the update of the structure of the schema set, it sends an approval/disapproval query about the update request to the aggregation management apparatus; when the database management apparatus receives an authorization request for the update request from the aggregation management apparatus, it sends a reply to the authorization request for approval/disapproval; and when the database management apparatus receives an approval/disapproval determination result from the aggregation management apparatus, it sends the updatability of the update request to the database, in which the update request occurs, on the basis of the approval/disapproval query. Furthermore, to ensure consistency with the structure of the schema set stored in the database that is the original source of the update request, the aggregation management apparatus stores, in advance, reference relation for specifying another database that stores a related schema set that needs to be updated according to an update of the structure of the schema set stored in a database that is the request source of the update request. When the aggregation management receives the approval/disapproval query from the database management apparatus, the aggregation management extracts the other database storing the associated schema set that needs to be updated to ensure the consistency on the basis of the reference relation, sends the authorization request for the update to the database management apparatus arranged in association with the extracted database, receives a reply to the authorization request for approval/disapproval sent from the database management apparatus, decides whether to approve the approval/disapproval query on the basis of the reply, and sends a decision result as the approval/disapproval determination result to the database management apparatus that is a sending source of the approval/disapproval query. In this way, according to the first embodiment, when the update request related to the update of the structure of the schema set occurs, by extracting the other database storing the schema set affected by the update and sending a collective query about the update authorization to the administrator who manages the other database to efficiently obtain the authorization for the update, which makes it possible to easily update the structure of the schema set.

Furthermore, according to the first embodiment, when it is decided to approve the update of all of the extracted databases, an update approval/disapproval decision result indicating approval of the update request is sent to the database that is the original source of the update request; therefore, it is possible to easily execute the update of the structure of the schema set by collectively obtaining the approval of the update from the administrator who manages the other database.

Furthermore, according to the first embodiment, when the content of the update request is not related to a structure change of the schema set, the update approval/disapproval decision result indicating the approval of the update request is sent to the database that is the original source of the update request; therefore, it is possible to easily execute the update of the structure of the schema set by sending a query about an approval/disapproval for the update only when an update request for the structure of the schema set occurs.

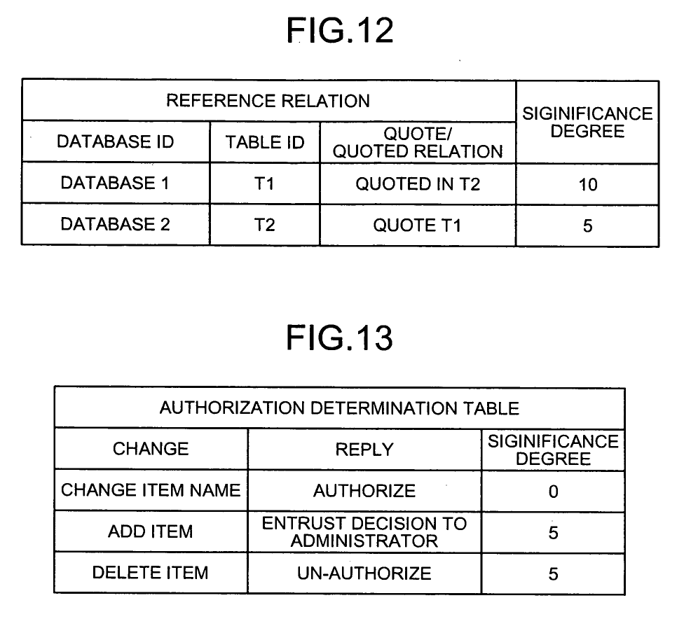

In the first embodiment, a case in which an approval/disapproval decision on the authorization request is made on the basis of the content of the update request is described; however, the present invention is not limited to this. For example, an approval/disapproval decision on the authorization request can be made on the basis of the significance of the approve/disapprove decision on the authorization request given in each table. A specific example of a case in which the aggregation management apparatus performs an approval/disapproval decision on the authorization request on the basis of significance of the approve/disapprove decision on the authorization request given in each table is described with reference to FIGS. 12 and 13. FIG. 12 is an example of a data table stored in the reference relation storing unit. FIG. 13 is an example of an authorization determination table.

As illustrated in FIG. 12, the reference relation storing unit 13a stores a database ID that is an identifier of the database storing referenced/quoted schema (for example, “database 1”); a table identifier that is an identifier of the data table stored in the database (for example, “T1”); a quote/quoted relation that is data indicating whether the data table is quoted for creating another data table (for example, “quoted in T2”), or data indicating that the data table is created on the basis of which data table (for example, “quote T1”); and significance for deciding whether to approve changes given in each table (for example, 10), which are associated with each other.

The storing unit 23 stores, in advance, an authorization determination table (see FIG. 13), in which changes (for example, changes in item names, or additions or deletions of items, etc.), replies (for example, approvals/disapprovals, entrusting decisions to the administrator, etc.), and the significance (for example 5) are associated with each other, and when the database management apparatus receives “a change indicating that the item name A in the data table 1 stored in the database 1 is changed to the item name B” from the aggregation management apparatus, the database management apparatus sends, by referring to the authorization determination table, significance (for example, 0) associated with the change as a reply to the authorization request for approval/disapproval.

When the approval/disapproval reply receiving unit 14b receives the significance associated with the change sent from the database management apparatus, the approval/disapproval reply receiving unit 14b compares the received significance with the significance stored in the reference relation storing unit 13a by referring to the reference relation storing unit 13a. When the degree of significance received is larger than that stored in the reference relation storing unit 13a, the approval/disapproval reply receiving unit 14b decides whether to authorize the authorization request as authorization for the change and executes a process in a case where “a reply of authorization for the change indicating that the item name A in the data table 1 stored in the database 1 is changed to the item name B” is received. In contrast, when the degree of significance received is smaller than that stored in the reference relation storing unit 13a, the approval/disapproval reply receiving unit 14b decides whether to authorize the authorization request as un-authorization for the change and executes a process in a case where “a reply of un-authorization for the change indicating that the item name A in the data table 1 stored in the database 1 is changed to the item name B” is received.

In this way, it is possible to easily execute the update of the structure of the schema set by deciding whether to authorize the authorization request on the basis of the degree of significance, which is given in each table, used for deciding whether to authorize the authorization request.

### [b] Second Embodiment

In the first embodiment described above, when a portion in which inconsistency that occurs between the structure of the schema set and the structure of the related schema set is present, data related to the portion in which the inconsistency occurs can be excluded from the reference relation. In a second embodiment described below, the configuration of the update management system according to the second embodiment is described first, and then advantages of the second embodiment are described.

Configuration of the Aggregation Management Apparatus (Second Embodiment)

First, the configuration of the aggregation management apparatus 10 in the update management system according to the second embodiment is described. The configuration of the aggregation management apparatus 10 according to the second embodiment is basically the same as that of the first embodiment and the operation thereof is the same as that of the first embodiment except for an excluding unit 14d described below; therefore, only differences from the aggregation management apparatus 10 according to the first embodiment are described in detail. The excluding unit 14d corresponds to an excluding step of the present invention.

When updating the structure of the schema set stored in the database that is the original source of the update request, if a portion where the inconsistency that occurs between the structure of the schema set and the structure of the related schema set is present, the excluding unit 14d excludes, from the reference relation, the data related to the portion where the inconsistency occurs.

The inconsistency mentioned here indicates a state where the structure of a prescribed schema set is updated, whereby the structure of the data thereof differs from that of the associated schema set. Furthermore, the inconsistency mentioned here indicates a state that adversely effects the associated schema set if the prescribed schema set is updated after updating the structure of the prescribed schema set.

Specifically, the excluding unit 14d deletes, from the reference relation, the quote/quoted relation (see FIG. 3) associated with the data table where the inconsistency between the prescribed schema set and the associated schema set occurs, caused by updating the structure of the schema set stored in the database that is the original source of the update request.

More specifically, by excluding the quote/quoted relation between the data table storing the prescribed schema set and the data table storing the associated schema set, and by deleting, from the reference relation, the quote/quoted relation associated with the data table where the inconsistency that occurs between the prescribed schema set and the associated schema set, the update of the associated schema set is not executed even when updating the prescribed schema set.

### Advantages of the Second Embodiment

In this way, when updating the structure of the schema set stored in the database that is the original source of the update request, if a portion where the inconsistency that occurs between the structure of the schema set and the structure of the related schema set is present, the update management system according to the second embodiment excludes, from the reference relation, the data related to the portion in which inconsistency occurs. Accordingly, it is possible to prevent the occurrence of the inconsistency of the schema set in the associated data table caused by updating the structure of the schema set.

### [c] Third Embodiment

The data, which is related to the portion where inconsistency occurs, excluded in the second embodiment described above can be saved again in a state that can be registered in the reference relation. In a third embodiment described below, the configuration of the update management system according to the third embodiment is described first, and then advantages of the third embodiment are described.

Configuration of the Aggregation Management Apparatus (Third Embodiment)

First, the configuration of the aggregation management apparatus 10 in the update management system according to the third embodiment is described. The configuration of the aggregation management apparatus 10 according to the third embodiment is basically the same as that of the second embodiment and the operation thereof is the same as that of the second embodiment except for a saving unit 14e described below; therefore, only differences from the aggregation management apparatus 10 according to the second embodiment are described in detail. The saving unit 14e corresponds to a saving step of the present invention.

The saving unit 14e saves the data, which is related to the portion where inconsistency occurs and excluded by the excluding unit 14d, in a state that can be registered in the reference relation in a hierarchical re-association manner. Specifically, the saving unit 14e stores, in the storing unit 13, the quote/quoted relation associated with the data table in which the structure of the schema set deleted from the reference relation is updated.

The quote/quoted relation associated with the data table, in which the structure of the schema set deleted from the reference relation is updated, is saved in a state that can be re-registered, which makes it easy to re-register the excluded reference relation.

### Advantages of the Third Embodiment

In this way, because the update management system according to the third embodiment saves the data, which is related to the portion where inconsistency occurs due to exclusion, in a state that can be registered in the reference relation in a hierarchical re-association manner, it is possible for the administrator who manages the database to easily re-associate data between the data tables by referring to the quote/quoted relation.

It has been mentioned that the data, which is related to the portion where inconsistency occurs and is excluded by the excluding unit 14d, is stored in a state that can be registered in the reference relation in a hierarchical re-association manner; however, it is also possible to extract reference relation that maintains consistency from among the reference relation, which is related to the portion where inconsistency occurs due to exclusion, and to re-register it in the reference relation.

For example, “T2” is assumed to be created by quoting “T1”, and “T3” is assumed to be further created by quoting “T2”. In this state, when an update request for the structure of the schema set related “T1” occurs and the update request is approved, by excluding a quote/quoted relation between “T1” and “T2”, a quote/quoted relation among “T1”, “T2”, and “T3” is also excluded accordingly. Here, table “T2” and table “T3” still maintain consistency because the structure of the schema set thereof has not been updated. It is possible to extract such an indirectly associated schema set and re-register it as new reference relation (for example, “T2” is quoted in “T3”).

In this way, by extracting the reference relation that maintains consistency from among the reference relation related to a portion where inconsistency occurs due to exclusion and re-registering it in the reference relation, it is possible for the administrator managing the database to easily re-associate data between the data tables by referring to the quote/quoted relation.

### [d] Fourth Embodiment

The first, second, and third embodiments have been described above; however, the present invention is not limited thereto and can be implemented with various kinds of configurations. Accordingly, another embodiment is described below as a fourth embodiment.

The present invention is not limited to even if the database management apparatus executes a process for restricting the update of the data with respect to the database when the update request occurs, and is further not limited to even if the database management apparatus executes a process for releasing the database from the update restriction on the data when receiving an approval/disapproval determination result indicating permission to execute the update of the structure of the schema set.

The second embodiment has been described in terms of a case in which the database ID, the table identifier, and the quote/quoted relation are associated with each other and stored in the reference relation storing unit 13a, and the quote/quoted relation associated with the data table, in which the structure of the schema set is updated, is deleted from the reference relation; however, the present invention is not limited thereto. For example, the database ID, the table identifier, the item name, and the quote/quoted relation can be associated with each other and stored in the reference relation storing unit 13a, and the quote/quoted relation, which is related to the item for updating the structure of the schema set, can be deleted from the reference relation.

System Configuration, Etc.

Of the processes described in the embodiment, the whole or a part of the processes that are mentioned as being automatically performed can be manually performed, or the whole or a part of the processes that are mentioned as being manually performed can be automatically performed using known methods. Furthermore, process procedures, the control procedures, the specific names, and the data containing various kinds of data or parameters indicated in the above specification and drawings (for example, storing data illustrated in FIGS. 1, 3, 4A to 4D, 6, 12, and 13) can be arbitrarily changed unless otherwise noted.

The components of the devices illustrated in the drawings are only for conceptually illustrating the functions thereof and are not necessarily physically configured as illustrated in the drawings. In other words, the specific shape of a separate or integrated device is not limited to way it is illustrated in the drawings; however, the whole or a part of the device can be configured by functionally or physically separating or integrating any units according to various loads or use conditions. (For example, in FIG. 2, the approval/disapproval reply receiving unit 14b can be integrated with the approval/disapproval query-result sending unit 14c). Furthermore, all or any of the processing functions performed by each unit can be implemented by a CPU and programs analyzed and executed by the CPU or implemented as wired logic hardware.

Update Management Program

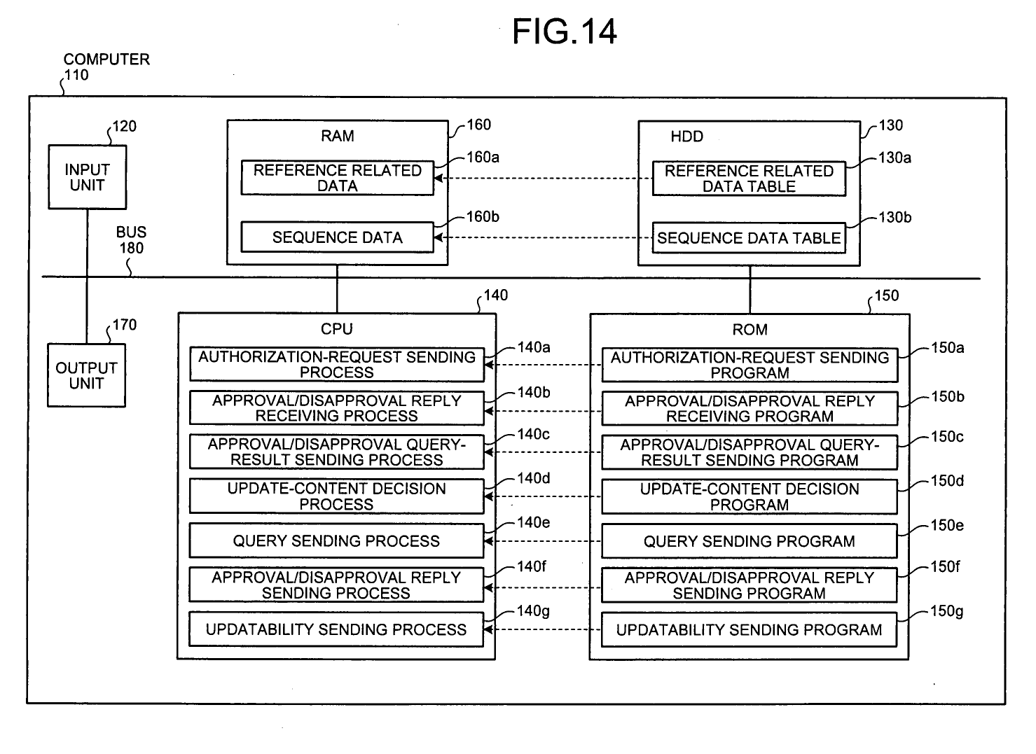

In the above-described embodiment, a case has been mentioned where various kinds of processes are implemented by hardware logic; however, the present invention is not limited thereto. For example, various processes can be implemented by programs prepared in advance and executed by a computer. An example of a computer that executes an update management program having the same functions as the update management apparatus described in the embodiment is described with reference to FIG. 14. FIG. 14 is a block diagram illustrating a computer that executes the update management program.

As illustrated in FIG. 14, a computer 110 serving as the update management system includes an input unit 120, an HDD 130, a CPU 140, a ROM 150, a RAM 160, and an output unit 170, which are connected via a bus 180 or the like.

The ROM 150 stores, in advance, the update management program exhibiting the same function as the update management system described in the first embodiment, i.e., as illustrated in FIG. 14, an authorization-request sending program 150a, an approval/disapproval reply receiving program 150b, an approval/disapproval query-result sending program 150c, an update-content decision program 150d, a query sending program 150e, an approval/disapproval reply sending program 150f, and an updatability sending program 150g. These programs 150a to 150g can appropriately be integrated or separated in the same manner as the aggregation management apparatus 10 illustrated in FIG. 2.

As illustrated in FIG. 14, because the CPU 140 reads and executes these programs 150a to 150g from the ROM 150, these programs 150a to 150g function as an authorization-request sending process 140a, an approval/disapproval reply receiving process 140b, an approval/disapproval query-result sending process 140c, an update-content decision process 140d, a query sending process 140e, an approval/disapproval reply sending process 140f, and an updatability sending process 140g, respectively. The processes 140a to 140g correspond to the authorization-request sending unit 14a, the approval/disapproval reply receiving unit 14b, the approval/disapproval query-result sending unit 14c, the update-content decision unit 24a, the query sending unit 24b, the approval/disapproval reply sending unit 24c, and the updatability sending unit 24d illustrated in FIG. 2 or 5, respectively.

As illustrated in FIG. 14, the HDD 130 includes a reference related data table 130a. The reference related data table 130a corresponds to the reference relation storing unit 13a illustrated in FIG. 2. The CPU 140 reads a reference related data 160a from the reference related data table 130a, stores it in the RAM 160, and executes processing on the basis of the reference related data 160a stored in the RAM 160.

Each of the programs 150a to 150g is not necessarily stored in the ROM 150 from the beginning. For example, the programs can be stored in a “portable physical medium” functioning as a computer-readable medium, such as a flexible disk (FD), a CD-ROM, a DVD disk, a magneto-optical disk, an IC card, and the like that can be inserted into the computer 110; and a “fixed physical medium” functioning as a computer-readable medium, such as an HDD that can be arranged inside/outside the computer 110. Further, the programs can be stored in “another computer (or a server)” connected to the computer 110 via a public line, the Internet, a LAN, a WAN, and the like from which the computer 110 reads and then executes the programs.

According to the present invention, when an update request related to an update of a structure of a schema set occurs, it is possible to easily execute the update of the structure of the schema set by extracting another database storing a schema set affected by the update and sending a collective query about update authorization to an administrator who manages a database to efficiently obtain the authorization for the update.

According to the present invention, the update of the structure of the schema set can be easily executed by sending a query about approval/disapproval of the update only when the update request for the structure of the schema set occurs.

According to the present invention, it is possible to prevent the occurrence of inconsistency of a schema set in an associated data table caused by updating the structure of the schema set.

According to the present invention, it is possible for the administrator managing the database to easily re-associate data between data tables by referring to a record of a quote/quoted relation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An update management method that performs a process with respect to an update request when the update request occurs in any one of a plurality of databases storing a prescribed schema, set that is distributed and hierarchically associated, the update management method comprising:
storing, in advance, reference relation for specifying other database storing a related schema set that needs to be updated in accordance with an update of a structure of a schema set stored in a database that is a request source of the update request to ensure consistency with a structure of a schema set stored in a database that is an original source of the update request;
deciding whether a content of the update request is related to a structure change of the schema set;
extracting, when the content of the update request is related to the structure change of the schema set at the deciding, on the basis of the reference relation stored at the storing, other database storing an associated schema set that needs to be updated to ensure the consistency and deciding whether to approve an update of the extracted database; and
sending an update approval/disapproval decision result decided at the deciding the update of the extracted database to the database that is the original source of the update request.

2. The update management method according to claim 1, wherein, when it is decided to approve the update of all of the extracted databases at the deciding the update of the extracted database, at the sending, the update approval/disapproval decision result indicating approval of the update request is sent to the database that is the original source of the update request.

3. The update management method according to claim 1, wherein, when the content of the update request is not related to the structure change of the schema set at the deciding the content of the update request, at the sending, the update approval/disapproval decision result indicating approval of the update request is sent to the database that is the original source of the update request.

4. The update management method according to claim 1, further comprising excluding, when updating the structure of the schema set stored in the database that is the original source of the update request, if a portion where the inconsistency that occurs between the structure of the schema set and the structure of the related schema set is present, from the reference relation stored in the storing unit at the storing, data related to the portion where inconsistency occurs.

5. The update management method according to claim 4, further comprising saving data, related to the portion where the inconsistency occurs and excluded at the excluding, in a state that can be registered in the reference relation in a hierarchically re-association manner.

6. A computer-readable storage medium that stores an update management program that causes a computer to process an update request when the update request occurs in any one of a plurality of databases storing a prescribed schema set that is distributed and hierarchically associated, the update management program causing the computer to execute a process comprising:
storing, in advance, in a storing unit, reference relation for specifying other database storing a related schema set that needs to be updated in accordance with an update of a structure of a schema set stored in a database that is a request source of the update request to ensure consistency with a structure of a schema set stored in a database that is an original source of the update request;
deciding whether a content of the update request is related to a structure change of the schema set;
extracting, when the content of the update request is related to the structure change of the schema set at the deciding, on the basis of the reference relation stored in the storing unit at the storing, other database storing an associated schema set that needs to be updated to ensure the consistency and then deciding whether to approve an update of the extracted database; and
sending an update approval/disapproval decision result decided at the deciding the update of the extracted database to the database that is the original source of the update request.

7. The computer-readable storage medium according to claim 6, wherein, when it is decided to approve the update of all of the extracted databases at the deciding the update of the extracted database, at the sending, the update approval/disapproval decision result indicating approval of the update request is sent to the database that is the original source of the update request.

8. The computer-readable storage medium according to claim 6, wherein, when the content of the update request is not related to the structure change of the schema set at the deciding the content of the update request, at the sending, the update approval/disapproval decision result indicating approval of the update request is sent to the database that is the original source of the update request.

9. The computer-readable storage medium according to claim 6, further causing the computer to execute excluding, when updating the structure of the schema set stored in the database that is the original source of the update request, if a portion where the inconsistency that occurs between the structure of the schema set and the structure of the related schema set is present, from the reference relation stored in the storing unit at the storing, data related to the portion where inconsistency occurs.

10. The computer-readable storage medium according to claim 9, further causing the computer to execute saving data, related to the portion where the inconsistency occurs and excluded at the excluding, in a state that can be registered in the reference relation in a hierarchically re-association manner.

11. An update management apparatus that performs a process with respect to an update request when the update request occurs in any one of a plurality of databases storing a prescribed schema set that is distributed and hierarchically associated, the update management apparatus comprising:
a reference relation storing unit that stores, in advance, reference relation for specifying other database storing a related schema set that needs to be updated in accordance with an update of a structure of a schema set stored in a database that is a request source of the update request to ensure consistency with a structure of a schema set stored in a database that is an original source of the update request;
an update-content decision unit that decides whether a content of the update request is related to a structure change of the schema set;
an update approval/disapproval deciding unit that extracts, when the update-content decision unit decides that the content of the update request is related to the structure change of the schema set, on the basis of the reference relation stored by the reference relation storing unit, other database storing an associated schema set that needs to be updated to ensure the consistency and decides whether to approve an update of the extracted database; and
an update approval/disapproval decision result sending unit that sends an update approval/disapproval decision result decided by the update approval/disapproval deciding unit to the database that is the original source of the update request.

12. The update management apparatus according to claim 11, wherein, when the update approval/disapproval deciding unit decides to approve the update of all of the extracted databases, the update approval/disapproval decision result sending unit sends an update approval/disapproval decision result indicating approval of the update request to the database that is the original source of the update request.

13. The update management apparatus according to claim 11, wherein, when the content of the update request is not related to the structure change of the schema set by the update-content deciding unit, the update approval/disapproval decision result sending unit sends an update approval/disapproval decision result indicating approval of the update request to the database that is the original source of the update request.

14. The update management apparatus according to claim 11, further comprising an excluding unit that excludes, when updating the structure of the schema set stored in the database that is the original source of the update request, if a portion where the inconsistency that occurs between the structure of the schema set and the structure of the related schema set is present, from the reference relation stored in a storing unit by the reference relation storing unit, data related to the portion where inconsistency occurs.

15. The update management apparatus according to claim 14, further comprising a saving unit that saves data, related to the portion where the inconsistency occurs and excluded by the excluding unit, in a state that can be registered in the reference relation in a hierarchically re-association manner.
